(19) United States
(12) Patent Application Publication
(10) Pub. No.: US 2026/0050247 A1
(43) Pub. Date: Feb. 19, 2026

(54) SYSTEMS, METHODS, AND MEDIA FOR A MANUFACTURING PROCESS

(71) Applicant: Nanotronics Imaging, Inc., Cuyahoga Falls, OH (US)

(72) Inventors: John B. Putman, Celebration, FL (US); Matthew C. Putman, Brooklyn, NY (US); Joanna Lee, Brooklyn, NY (US); Damas Limoge, Brooklyn, NY (US); Jonathan Bobrow, New York, NY (US)

(73) Assignee: Nanotronics Imaging, Inc., Cuyahoga Falls, OH (US)

(21) Appl. No.: 19/301,299

(22) Filed: Aug. 15, 2025

Related U.S. Application Data
(60) Provisional application No. 63/683,749, filed on Aug. 16, 2024.

(51) Int. Cl. G05B 19/4063; G06N 3/0455

(52) U.S. Cl. CPC G05B 19/4063; G06N 3/0455; G05B 2219/32335

(57) ABSTRACT

Various embodiments relate to a method for analyzing manufacturing process data. The method includes: receiving, by a processor, a sequence of sensor outputs from a plurality of sensors monitoring a manufacturing process; predicting, using a transformer model executed by the processor, future manufacturing process parameters based on the sensor outputs; generating one or more key influencers on a current system state based on an attention matrix of the transformer model; analyzing the predicted parameters to identify an out-of-specification parameter; and identifying one or more key contributors to the out-of-specification parameter based on the attention matrix of a transformer head associated therewith.

### CROSS-REFERENCE TO RELATED APPLICATIONS

This application claims the benefit of U.S. Provisional Application Nos. 63/683,749 filed Aug. 16, 2024, which is hereby incorporated by reference in its entirety.

### FIELD OF DISCLOSURE

Embodiments disclosed herein generally relate to an improved approach to improving or optimizing manufacturing processes of a manufacturing process in a manufacturing environment in a manner that results in a fully or partially autonomous manufacturing system.

### BACKGROUND

To manufacture products that consistently meet desired design specifications, safely, timely and with minimum waste, requires constant monitoring and adjustments to the manufacturing process.

Traditional manufacturing systems rely on statistical process control techniques and manual oversight to detect deviations from normal operating conditions. However, these conventional approaches often analyze individual process parameters in isolation, which can limit their ability to identify complex relationships between multiple variables that influence product quality and process performance.

Modern manufacturing environments generate vast amounts of sensor data from temperature monitors, pressure transducers, flow controllers, and other instrumentation distributed throughout production systems. This data contains valuable information about process dynamics and potential quality issues, but extracting actionable insights from multiple concurrent data streams presents computational challenges. Existing monitoring systems may fail to detect subtle patterns or correlations that could indicate emerging problems before they result in defective products or equipment failures.

The semiconductor manufacturing industry exemplifies these challenges, where processes involve numerous interdependent variables that must be precisely controlled to achieve desired material properties and device characteristics. Traditional analysis methods may not provide sufficient predictive capability or real-time feedback to enable proactive process adjustments. Enhanced analytical approaches that can process multiple sensor inputs simultaneously and identify relationships between process parameters and final product quality would provide manufacturers with improved tools for process optimization and quality control.

### SUMMARY

In some embodiments, a method is disclosed herein. A computing system receives sensor data from one or more sensors disposed in a manufacturing system configured to perform a manufacturing process. The computing system generates predicted values for one or more key performance indicators (KPIs) based on the sensor data. The computing system identifies one or more key influencers for the predicted values. The computing system identifies an anomaly in the manufacturing process based on the predicted values and/or the one or more key influencers.

In some embodiments, a system for analyzing manufacturing process data includes a plurality of sensors configured to monitor a manufacturing process and generate sensor outputs; a processor; and a memory storing instructions that, when executed by the processor, cause the processor to: receive a sequence of sensor outputs from the plurality of sensors; predict, using a transformer model, future parameters of the manufacturing process based on the sequence of sensor outputs; generate one or more key influencers on a current system state based on an attention matrix of the transformer model; analyze the predicted parameters to identify an out-of-specification parameter; and identify one or more key contributors to the out-of-specification parameter based on an attention matrix of a transformer head associated with the out-of-specification parameter.

In some embodiments, a non-transitory computer-readable medium storing instructions that, when executed by a processor, causes the processor to perform a method for analyzing manufacturing process data, the method including receiving a sequence of sensor outputs from a plurality of sensors monitoring a manufacturing process; predicting, by a transformer model, future parameters of the manufacturing process based on the sequence of sensor outputs; generating one or more key influencers on a current system state based on an attention matrix of the transformer model; analyzing the predicted parameters to identify an out-of-specification parameter; and identifying one or more key contributors to the out-of-specification parameter based on an attention matrix of a transformer head associated with the out-of-specification parameter.

### BRIEF DESCRIPTION OF THE DRAWINGS

The accompanying drawings, which are incorporated herein and form part of the specification, illustrate the present disclosure and, together with the description, further serve to explain the principles of the present disclosure and to enable a person skilled in the relevant art(s) to make and use embodiments described herein.

FIG. 1 depicts an exemplary Supervisory Control and Data Acquisition system in accordance with example embodiments.

FIG. 2 depicts an illustrative system for analyzing sensor data in a manufacturing process in accordance with example embodiments.

FIG. 3 depicts an exemplary transformer system for processing time series sensor data in accordance with example embodiments.

FIG. 4 depicts an illustrative method for analyzing manufacturing process data using a transformer in accordance with example embodiments.

FIG. 5 depicts an exemplary method for analyzing a manufacturing process with quality metric evaluation in accordance with example embodiments.

FIG. 6 depicts an illustrative graphical user interface for analyzing manufacturing process data in accordance with example embodiments.

FIG. 7 depicts an exemplary graphical user interface with key contributors over time visualization in accordance with example embodiments.

FIG. 8 depicts an illustrative graphical user interface for key performance indicator prediction and analysis in accordance with example embodiments.

FIG. 9 depicts an exemplary graphical user interface for monitoring manufacturing process parameters in accordance with example embodiments.

FIG. 10 depicts an illustrative graphical user interface for monitoring a specific sensor in accordance with example embodiments.

FIG. 11 depicts an exemplary graph showing temperature sensor predicted versus measured values in accordance with example embodiments.

FIG. 12 depicts an illustrative graphical user interface for monitoring components in a manufacturing process in accordance with example embodiments.

FIG. 13A is a block diagram illustrating a computing device, in accordance with example embodiments.

FIG. 13B is a block diagram illustrating a computing device, in accordance with example embodiments.

The features of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. Additionally, generally, the left-most digit(s) of a reference number identifies the drawing in which the reference number first appears. Unless otherwise indicated, the drawings provided throughout the disclosure should not be interpreted as to-scale drawings.

### DETAILED DESCRIPTION

This disclosure is not limited to the particular systems, devices and methods described, as these may vary. The terminology used in the description is for the purpose of describing the particular versions or embodiments only and is not intended to limit the scope.

The present disclosure provides systems, methods, and media for analyzing manufacturing process data using transformer-based machine learning models to predict future parameters and identify anomalous conditions in real-time. The system receives sequential sensor outputs from multiple monitoring devices distributed throughout a manufacturing environment and processes this data through a transformer model that incorporates attention mechanisms to understand complex relationships between process variables. The transformer model generates predictions for future manufacturing parameters and quality metrics while simultaneously producing attention matrices that reveal which sensors or process elements have the greatest influence on current system behavior and predicted outcomes.

When the system identifies out-of-specification parameters or quality metrics that deviate from expected values, it analyzes the attention matrices from specialized transformer heads to determine the key contributors to these deviations. This approach enables manufacturing operators to understand not only when problems may occur, but also which specific process elements are responsible for quality issues or anomalous behavior. The system may present this analytical information through comprehensive graphical user interfaces that display time-series visualizations of sensor data, percentage contributions of key influencers, and real-time assessments of manufacturing quality metrics, enabling proactive process adjustments and targeted corrective actions before defective products or equipment failures occur.

There are several problems with the current state of technology. For example, customer trial or new process development is traditionally a time consuming and complicated process that involves many variables for recipe setting, which can take a minimum of two to three weeks to establish. Traditional techniques typically require manual reporting, which adds to the time-consuming nature of the process. As those skilled in the art recognize, traditional techniques are slow (e.g., engineer time is spent on failure analysis and operators are typically required to be on-site), result in increased down-time (e.g., customer's tools are not operational while waiting) and poor yield. As a result of these limitations, existing techniques typically block clients from gaining revenue, as it becomes more difficult and time-consuming to meet the objectives of the customer.

One or more techniques described herein improve upon the limitations in conventional technology by providing an intelligent system configured to automate the process control analysis for manufacturing processes. In some embodiments, the system may be configured to predict values for key performance indicators (KPIs) identify key contributors (e.g., key influencers) associated with the predicted values, and then use key influencers to change the process to improve the KPI values. In some embodiments, the system may be configured to detect anomalies in the manufacturing process. For example, the system may be configured to identify anomalies by predicting that something in the process is behaving differently or is being predicted to behave differently. Such an approach may be useful when, for example, the process engineer can prevent a problem before it occurs. Indirectly, such functionality can improve a KPI, but the action also can used directly to prevent an anomaly. In other words, maintaining the status quo does not necessarily improve a KPI value. In some embodiments, the system may be configured to generate a digital dashboard interface to visualize and/or achieve the foregoing functionalities.

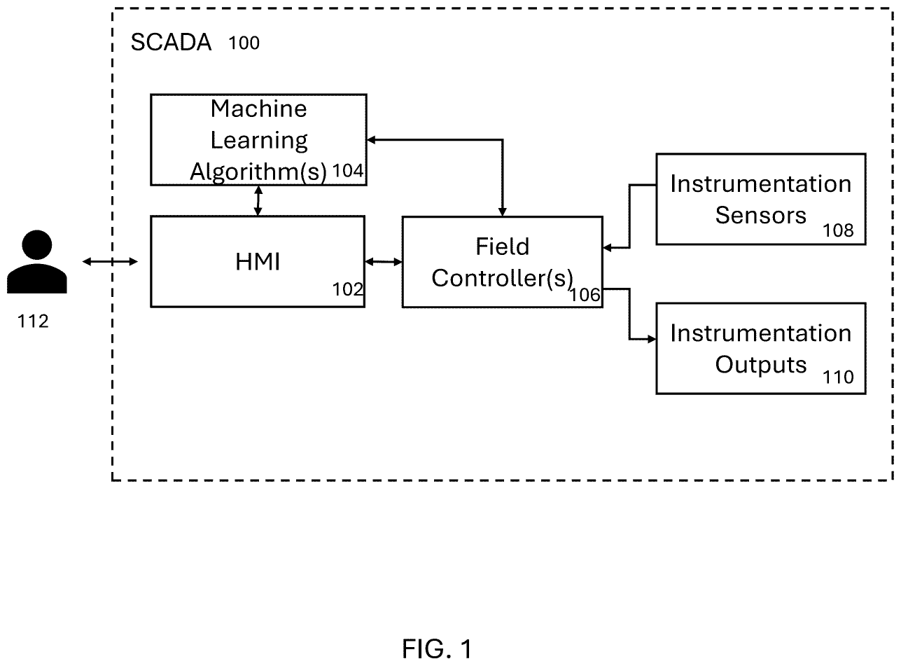

FIG. 1 depicts an exemplary Supervisory Control and Data Acquisition (SCADA) system 100, in accordance with example embodiments. The SCADA system 100 provides a comprehensive architecture for monitoring and controlling manufacturing processes through integrated data collection and processing capabilities. The SCADA system 100 includes multiple interconnected components that work together to enable real-time process oversight and automated control functions. A human machine interface (HMI) 102 serves as the central communication hub within the SCADA system 100, facilitating interaction between users (e.g., operators) 112 and the manufacturing process control elements. The HMI 102 interfaces with a machine learning algorithm 104, allowing for the real-time analysis described herein.

The HMI 102 also receives communication with one or more field controllers 106, which function as intermediate processing units within the SCADA system 100. The field controllers 106 may receive operational commands from the HMI 102 and/or the machine learning algorithm 104 and translate these commands into appropriate control signals for manufacturing equipment. In some cases, the field controllers 106 serve as data aggregation points, collecting information from various monitoring devices and forwarding processed data back to the HMI 102 and/or the machine learning algorithm 104 for display and analysis purposes.

The field controllers 106 may include programmable logic controllers (PLCs), distributed control systems (DCS), remote terminal units (RTUs), or industrial personal computers (IPCs) that provide real-time control and data acquisition capabilities within the manufacturing environment. The field controllers 106 may also include specialized process controllers such as temperature controllers, flow controllers, or pressure controllers that provide dedicated control functions for specific manufacturing parameters.

Multiple sensors 108 connect to the field controllers 106 to provide continuous monitoring of manufacturing process parameters. The sensors 108 may include temperature sensors, pressure sensors, flow rate sensors, vibration sensors, or other measurement devices depending on the specific manufacturing application. In some embodiments, the sensors 108 may include imaging devices. Data from the sensors 108 flows to the field controllers 106, where initial processing and conditioning may occur before transmission to higher-level system components. The field controllers 106 may perform data validation, filtering, and preliminary analysis on sensor data to ensure data quality and reduce communication bandwidth requirements.

Instrumentation output 110 receives control signals from the field controllers 106 to implement process adjustments and maintain desired operating conditions. The instrumentation output 110 may include actuators, valves, motors, heaters, or other control devices that directly influence manufacturing process parameters. In some embodiments, the instrumentation output 110 may allow the SCADA system 100 to control process flow, potentially activating/deactivating manufacturing equipment to avoid anomalous devices. In some cases, the field controllers 106 generate control signals based on sensor feedback, operator commands received through the HMI 102, or recommendations from the machine learning algorithm 104. The bidirectional connection between the field controllers 106 and instrumentation output 110 allows for feedback confirmation of control actions and status reporting.

As further shown in FIG. 1, a user 112 interacts with the SCADA system 100 through the HMI 102 to monitor process conditions, adjust operating parameters, and respond to system alerts or anomalies. The user 112 may access real-time data displays, historical trend information, and analytical results generated by the machine learning algorithm 104. The machine learning algorithm 104 processes data collected from the sensors 108 through the field controllers 106 and HMI 102 to identify patterns, predict process behavior, and recommend optimization strategies. This integrated architecture enables the SCADA system 100 to provide both manual oversight capabilities through the user 112 and HMI 102, as well as automated intelligence through the machine learning algorithm 104 for enhanced process control and optimization.

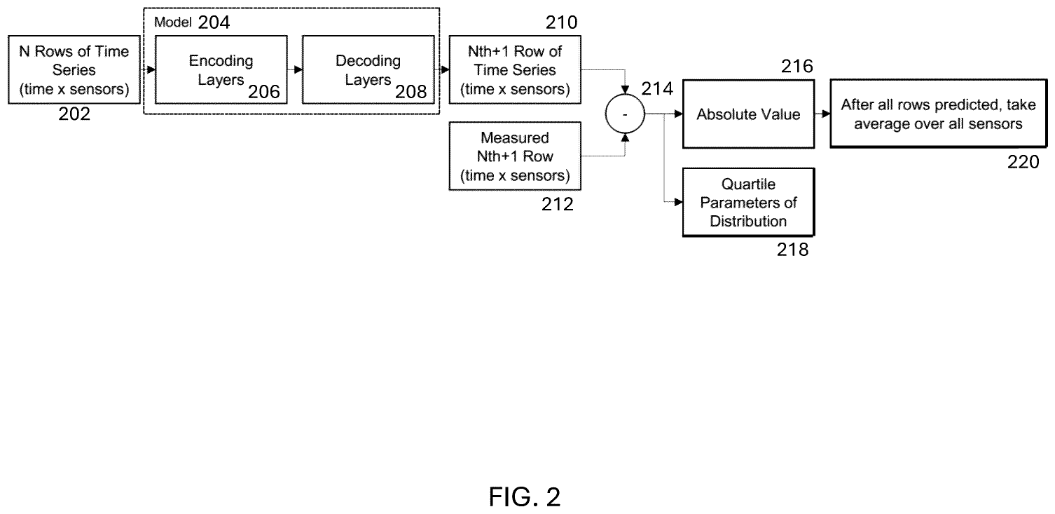

FIG. 2 depicts an illustrative system 200 for analyzing sensor data in a manufacturing process in accordance with example embodiments The system 200 may includes elements of the SCADA system 100, particularly the machine learning algorithm 104. The system 200 may provide an approach for analyzing sensor data collected from manufacturing processes through advanced computational techniques. The system 200 receives a time series sensor input 202 that contains sequential measurements from multiple monitoring devices over specified time intervals. In some cases, the time series sensor input 202 may include data streams from the sensors 108 within the SCADA system 100, where each sensor contributes continuous measurements of process parameters such as temperature, pressure, flow rates, or other manufacturing variables. The time series sensor input 202 may be formatted as a multi-dimensional dataset where rows represent time stamps and columns represent individual sensor measurements, allowing for comprehensive analysis of temporal patterns and inter-sensor relationships.

The system 200 may process the time series sensor input 202 through a model 204 that incorporates machine learning capabilities for predictive analysis and pattern recognition. The model 204 may utilize neural network architectures or other artificial intelligence techniques to learn complex relationships between sensor measurements and process outcomes. In some cases, the model 204 may be integrated with or complement the machine learning algorithm 104 within the SCADA system 100 to provide enhanced analytical capabilities. The model 204 may be trained on historical manufacturing data to develop predictive capabilities that can anticipate future process behavior based on current sensor readings.

The model 204 may include encoding layers 206 that transform the time series sensor input 202 into compressed representations suitable for analysis and prediction. The encoding layers 206 may apply mathematical transformations to reduce dimensionality while preserving relevant information contained within the sensor data streams. In some cases, the encoding layers 206 may utilize techniques such as feature extraction, data compression, or representation learning to convert raw sensor measurements into encoded formats that capture underlying process dynamics. The encoding layers 206 may process multiple sensor channels simultaneously, creating integrated representations that account for correlations and dependencies between different measurement sources.

As further shown in FIG. 2, the model 204 may incorporate decoding layers 208 that reconstruct sensor predictions from the encoded representations generated by the encoding layers 206. The decoding layers 208 may apply inverse transformations to convert compressed data representations back into sensor measurement formats for comparison with actual process conditions. In some cases, the decoding layers 208 may generate predictions for future time steps, allowing the system 200 to anticipate process behavior before actual measurements become available. The decoding layers 208 may produce outputs that correspond to expected sensor readings under normal operating conditions, providing a baseline for anomaly detection and process optimization.

The system 200 may generate a predicted sensor output 210 through the combined processing of the encoding layers 206 and decoding layers 208 within the model 204. The predicted sensor output 210 represents the model's estimation of what sensor measurements should be under current process conditions and historical patterns. In some cases, the predicted sensor output 210 may include confidence intervals or uncertainty estimates that indicate the reliability of predictions for different sensors or time periods. The predicted sensor output 210 may be formatted to match the structure of the original time series sensor input 202, enabling direct comparison with actual measurements.

The system 200 may measure sensor output 212 that contains actual readings from manufacturing process sensors during the same time periods covered by the predicted sensor output 210. The measured sensor output 212 may be collected in real-time from the sensors 108 through the field controllers 106 within the SCADA system 100. In some cases, the measured sensor output 212 may undergo preprocessing steps such as filtering, calibration, or synchronization to ensure compatibility with the predicted sensor output 210 for accurate comparison. The measured sensor output 212 allows for identification of deviations from expected process behavior.

The system 200 may perform a comparison 214 between the predicted sensor output 210 and the measured sensor output 212 to quantify prediction accuracy and identify process anomalies. The comparison 214 may calculate differences between predicted and measured values for each sensor and time step, generating error metrics that indicate process stability. In some cases, the comparison 214 may apply statistical techniques to account for measurement noise, sensor drift, or other factors that could affect the accuracy of the analysis. The comparison 214 may produce difference signals that highlight periods when actual process behavior deviates from model predictions, potentially indicating process disturbances or equipment malfunctions.

The system 200 may calculate an absolute value 216 from the results of the comparison 214 to eliminate the directional component of prediction errors and focus on the magnitude of deviations. The absolute value 216 may be computed for each sensor and time step, providing a consistent metric for evaluating prediction accuracy regardless of whether actual measurements are above or below predicted values. In some cases, the absolute value 216 may be normalized or scaled to account for different sensor ranges or measurement units, enabling fair comparison across diverse sensor types. The absolute value 216 may serve as input for subsequent statistical analysis and anomaly detection algorithms within the system 200.

The system 200 may determine quartile parameters 218 from the distribution of absolute values calculated across sensors and time periods. The quartile parameters 218 may include statistical measures such as the first quartile, median, third quartile, and interquartile range that characterize the distribution of prediction errors. In some cases, the quartile parameters 218 may be calculated separately for different sensor types, process phases, or time intervals to provide more detailed insights into model performance and process behavior. The quartile parameters 218 may be used to establish thresholds for anomaly detection, where deviations beyond certain quartile boundaries indicate unusual process conditions that warrant investigation.

As further shown in FIG. 2, the system 200 may generate a sensor average 220. The sensor average 220 may represent a weighted or filtered average that accounts for the statistical distribution of prediction errors across all sensors in the manufacturing system. In some cases, the sensor average 220 may be calculated using robust statistical techniques that reduce the influence of outliers or anomalous measurements on the overall assessment. The sensor average 220 may serve as a key performance indicator that summarizes the predictability and stability of the manufacturing process, providing operators and control systems with actionable information for process optimization and maintenance planning.

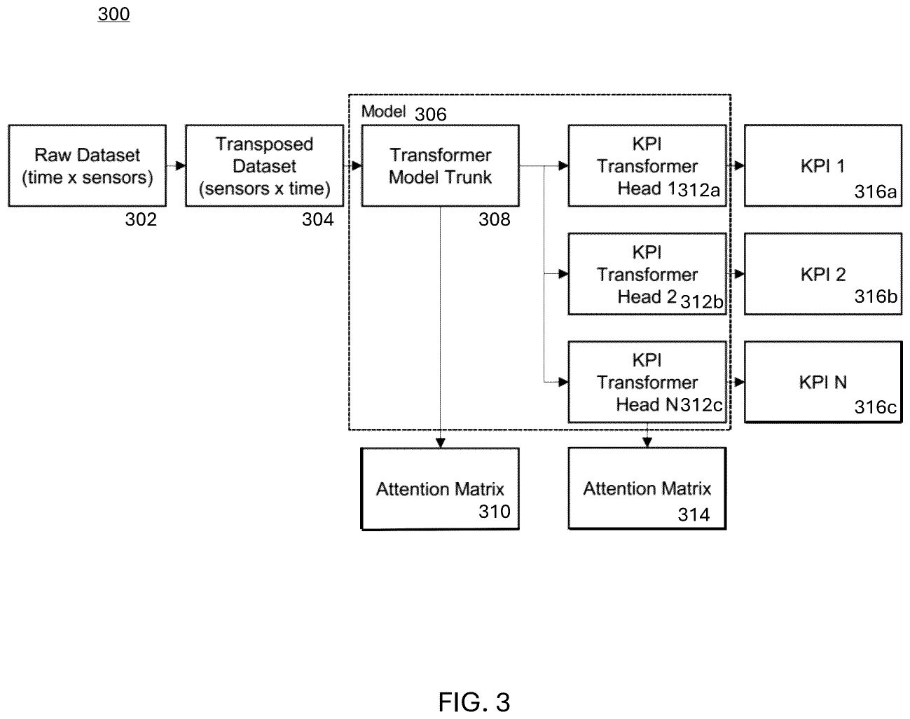

FIG. 3 depicts an exemplary transformer system 300 for processing time series sensor data in accordance with example embodiments. The transformer system 300 provides an advanced computational architecture for processing manufacturing sensor data through specialized machine learning components designed for sequential data analysis. The transformer system 300 may be integrated with or complement the SCADA system 100 to enhance analytical capabilities beyond traditional control system functions. In some cases, the transformer system 300 may receive data streams from the sensors 108 through the field controllers 106, where the collected measurements undergo preprocessing and formatting before entering the transformer-based analysis pipeline. The transformer system 300 may utilize attention mechanisms and parallel processing capabilities to identify complex patterns and relationships within multi-sensor manufacturing data that conventional analysis methods might not detect.

The transformer system 300 may receive a time series sensor input 302 that contains sequential measurements organized in a temporal format suitable for transformer-based processing. The time series sensor input 302 may represent a raw dataset structured with time dimensions along one axis and sensor measurements along another axis, creating a matrix format where each row corresponds to a specific time stamp and each column represents readings from individual sensors. In some cases, the time series sensor input 302 may include synchronized data from multiple sensor types within the manufacturing environment, such as temperature sensors, pressure transducers, flow meters, or vibration monitors. The time series sensor input 302 may undergo initial validation and quality checks to ensure data integrity before proceeding to subsequent processing stages within the transformer system 300.

The transformer system 300 may preprocess the dataset. For example, the transformer system 300 may process the time series sensor input 302 to generate a transposed dataset 304 that reorganizes the data structure to optimize transformer model performance and computational efficiency. The transposed dataset 304 may rearrange the original time series format so that sensors become the primary dimension and time becomes the secondary dimension, creating a sensors-by-time matrix structure. In some cases, the transposed dataset 304 may facilitate parallel processing of sensor channels through the transformer architecture, allowing each sensor's temporal patterns to be analyzed simultaneously rather than sequentially. Preprocessing may also incorporate normalization, scaling, or other preprocessing operations that prepare the data for optimal performance within the transformer model components.

As further shown in FIG. 3, the transformer system 300 incorporates a transformer model 306 that applies attention-based neural network architectures to analyze the transposed dataset 304 and extract meaningful patterns from the multi-sensor time series data. The transformer model 306 may utilize self-attention mechanisms that allow the model to focus on relevant portions of the input data when making predictions or identifying anomalies. In some cases, the transformer model 306 may be trained on historical manufacturing data to learn normal operating patterns and develop the capability to detect deviations from expected sensor behavior. The transformer model 306 may process multiple sensor channels in parallel, enabling the identification of cross-sensor correlations and dependencies that might indicate process interactions or system-wide phenomena.

The transformer model 306 may implement a multi-layered neural network architecture that processes sequential data through encoder and decoder components connected by attention mechanisms. The encoder portion may consist of multiple identical layers, each containing a multi-head self-attention mechanism followed by position-wise feed-forward networks, with residual connections and layer normalization applied around each sub-layer. The multi-head attention mechanism may allow the model to jointly attend to information from different representation subspaces at different positions, enabling the capture of various types of relationships within the input sequence. The decoder may follow a similar structure but includes an additional attention layer that performs attention over the output of the encoder stack, allowing the model to focus on relevant parts of the input sequence when generating predictions. Position encodings may be added to the input embeddings to provide the model with information about the relative or absolute position of tokens in the sequence, since the transformer architecture lacks inherent sequential processing capabilities. The attention mechanisms may compute attention weights through scaled dot-product attention, where queries, keys, and values are derived from the input representations through learned linear transformations, enabling the model to dynamically focus on different parts of the input based on their relevance to the current processing context.

The transformer model 306 includes a model trunk 308 that serves as the central processing component for analyzing the preprocessed dataset 304 through shared computational layers. The model trunk 308 may apply attention mechanisms and feed-forward neural network operations to extract common features and patterns that are relevant across multiple sensors and time periods.

In some cases, the model trunk 308 may learn representations that capture fundamental manufacturing process dynamics, equipment behavior patterns, or environmental influences that affect multiple measurement channels simultaneously. The model trunk 308 may generate intermediate representations that serve as input for transformer heads designed to predict specific manufacturing outcomes or quality metrics.

The model trunk 308 generates a trunk attention matrix 310 that quantifies the relative importance of different input elements during the analysis process. The trunk attention matrix 310 may contain numerical weights that indicate which sensors, time periods, or data combinations contribute most significantly to the model's understanding of current process conditions. In some cases, the trunk attention matrix 310 may be visualized or analyzed to provide insights into which manufacturing parameters have the greatest influence on overall process behavior. The trunk attention matrix 310 may serve as a foundation for generating more specialized attention patterns within individual transformer heads that focus on specific manufacturing outcomes or quality indicators.

The transformer system 300 may incorporate multiple transformer layers (e.g., transformer layer 1 312a, transformer layer 2 312b . . . transformer layer n 312c) that based on the model trunk 308 generate predictions for specific manufacturing quality metrics. Each transformer head within the transformer system 300 may represent a specialized attention mechanism that focuses on different aspects of the input data relationships and patterns. An transformer head may compute attention weights that determine which parts of the input sequence are most relevant for a particular prediction task or quality metric. In some cases, each transformer head may learn to attend to different types of temporal patterns, sensor correlations, or process characteristics within the manufacturing data, enabling the transformer model 306 to capture multiple types of relationships simultaneously. The transformer heads may utilize query, key, and value matrices derived from the model trunk 308 output to calculate attention scores that indicate the relevance of different input elements for specific manufacturing outcomes. Multiple transformer heads operating in parallel may enable the transformer model 306 to process various aspects of the sensor data concurrently, where each head contributes specialized insights that collectively enhance the model's ability to predict manufacturing quality metrics and identify process anomalies.

The transformer system 300 may generate a transformer head n attention matrix 314 that captures the attention patterns specific to the transformer head n 312c during its analysis of the model trunk 308 output. The transformer head n attention matrix 314 may contain weights that indicate which input features, sensors, or time periods are most relevant for predicting the specific manufacturing outcome associated with the transformer head n 312c. In some cases, the transformer head n attention matrix 314 may differ significantly from the trunk attention matrix 310, reflecting the specialized focus of individual transformer heads on particular manufacturing quality metrics. The transformer head n attention matrix 314 may be used to identify which sensors or process parameters contribute most significantly to specific quality outcomes, providing valuable insights for process optimization and control. In some embodiments, the specific transformer head n 312c may correspond to final quality metric of a product of the manufacturing process. A final quality metric may be. Generally, a final quality metric is a metric that represents a property of a component that underwent a manufacturing process and one that cannot be measured until each step of the manufacturing process is complete. In other words, the final quality metric is a property of a component that cannot be measured at each step of the manufacturing process. Exemplary final quality metrics may include, but are not limited to, tensile strength, hardness, thermal properties of the final product, and the like. For certain final quality metrics, such as tensile strength, destructive testing is used for measuring this metric. For example, in a four step manufacturing process, the final quality metrics of a component that undergoes the four step manufacturing process cannot be measured until the component underwent each of the four steps in the manufacturing process. In other words, assuming a sequential ordering of steps, the final quality metric cannot be measured at step 1, step 2, or step 3 of the manufacturing process.

As further shown in FIG. 3, the transformer system 300 may produce outputs for each transformer head, including a KPI 1 316a, a KPI 2 316b . . . KPI n 316c, that represent predicted values for different manufacturing performance indicators. Each KPI output may correspond to a specific manufacturing quality metric, process parameter, or performance indicator that is relevant for monitoring and controlling the manufacturing process. The multiple KPI outputs may be generated simultaneously from the same sensor input data, providing comprehensive predictions that enable proactive process management and quality control decisions within the manufacturing environment.

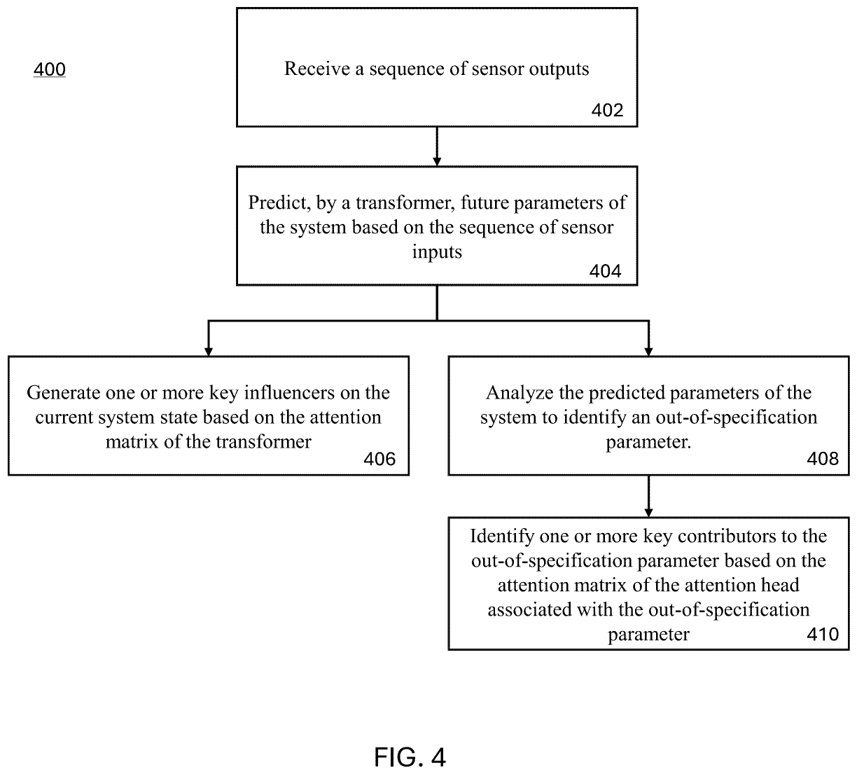

FIG. 4 depicts an illustrative method 400 that provides a systematic approach for analyzing manufacturing process data through transformer-based computational techniques that enable predictive analysis and anomaly detection within industrial environments, according to example embodiments. In some embodiments, the method 400 may be implemented within the SCADA system 100 to utilize the analytical capabilities of the machine learning algorithm 104. In some cases, the method 400 may process data streams collected from the sensors 108 through the field controllers 106, where the sequential sensor measurements undergo specialized analysis to predict future manufacturing parameters and identify process deviations. The method 400 may utilize attention mechanisms and parallel processing pathways to simultaneously generate insights about system influencers and detect out-of-specification conditions that could affect manufacturing quality or equipment performance.

The method 400 may include a step 402 that receives a sequence of sensor outputs from multiple monitoring devices distributed throughout the manufacturing environment. The step 402 may collect time-ordered measurements from the sensors 108 within the SCADA system 100, where each sensor contributes continuous data streams representing various process parameters such as temperature, pressure, flow rates, vibration levels, or chemical concentrations. In some cases, the step 402 may include synchronizing data collection across different sensor types to ensure temporal alignment and enable accurate analysis of inter-sensor relationships. The step 402 may also include initial data validation and quality checks to identify missing measurements, sensor malfunctions, or communication errors that could affect subsequent analysis steps within the method 400.

The method 400 may include a step 404 that utilizes a transformer model to predict future parameters of the manufacturing system based on the sequence of sensor inputs received in the step 402. The step 404 may implement the transformer model 306 or similar neural network architectures that incorporate attention mechanisms for analyzing sequential data patterns. The step 404 may generate predictions for multiple time horizons, allowing manufacturing operators to anticipate process changes and implement preventive measures before quality issues or equipment failures occur.

The method 400 may include a step 406 that generates one or more influencers on the current system state based on an attention matrix of the transformer model. The step 406 may analyze the trunk attention matrix 310 or similar attention patterns generated during the transformer processing in the step 404 to identify which sensors, time periods, or data combinations contribute most significantly to the current understanding of manufacturing process conditions. In some cases, the step 406 may rank sensors or process parameters according to their attention weights, providing manufacturing operators with insights into which factors have the greatest influence on overall system behavior. The step 406 may generate visualizations or reports that highlight the most influential process elements, enabling targeted monitoring and control efforts that focus on the parameters with the highest impact on manufacturing outcomes.

The method 400 may include a step 408 that analyzes the predicted parameters generated in the step 404 to identify out-of-specification conditions within the manufacturing process. The step 408 may compare predicted values against predetermined specification limits, tolerance ranges, or quality standards to detect parameters that deviate from acceptable operating conditions. In some cases, the step 408 may apply statistical analysis techniques to account for measurement uncertainty, process variability, or prediction confidence intervals when determining specification compliance. The step 408 may generate alerts or notifications when out-of-specification conditions are detected, enabling proactive intervention before actual manufacturing defects or quality issues occur.

Following the identification of out-of-specification parameters in the step 408, the method 400 may proceed to a step 410 that determines one or more contributors to the detected specification violations based on attention matrices associated with specific transformer heads associated with the parameter. The step 410 may analyze the transformer head attention matrix 314 or similar attention patterns generated by specialized transformer heads that focus on particular manufacturing quality metrics or performance indicators. In some cases, the step 410 may examine attention weights within transformer heads that correspond to the specific out-of-specification parameters identified in the step 408, revealing which sensors or process elements contribute most significantly to the detected deviations. The step 410 may provide detailed attribution analysis that helps manufacturing engineers understand the root causes of quality issues and implement targeted corrective actions to address the underlying process problems.

In some embodiments, the method 400 may include the SCADA system 100 automatically taking corrective action based on the out-of-specification parameters. The SCADA system 100 may implement various automatic corrective actions in response to detected out-of-specification parameters to maintain manufacturing quality and process stability. In some cases, when temperature deviations are identified through the step 408, the SCADA system 100 may automatically adjust heating element power levels, modify cooling system flow rates, or alter ventilation parameters through the instrumentation output 110 to restore temperature uniformity within specification limits. When pressure or flow rate anomalies are detected, the system may automatically regulate valve positions, adjust pump speeds, or modify gas flow controller settings through the field controllers 106 to compensate for detected deviations and prevent quality metric degradation. The SCADA system 100 may also implement predictive control adjustments based on attention matrix analysis from the transformer model 306, where the system proactively modifies process parameters before anomalies fully develop, such as adjusting precursor gas ratios in semiconductor manufacturing processes when early indicators suggest potential thickness uniformity issues. In some aspects, the system may automatically reduce manufacturing throughput, activate backup equipment, or initiate controlled shutdown sequences when critical out-of-specification conditions are detected that could pose safety risks or result in significant product quality failures. The automatic corrective actions may be coordinated through a machine learning algorithm, which may prioritize interventions based on the severity of detected anomalies and the potential impact on manufacturing outcomes, enabling the system to maintain optimal process conditions while minimizing disruption to production operations.

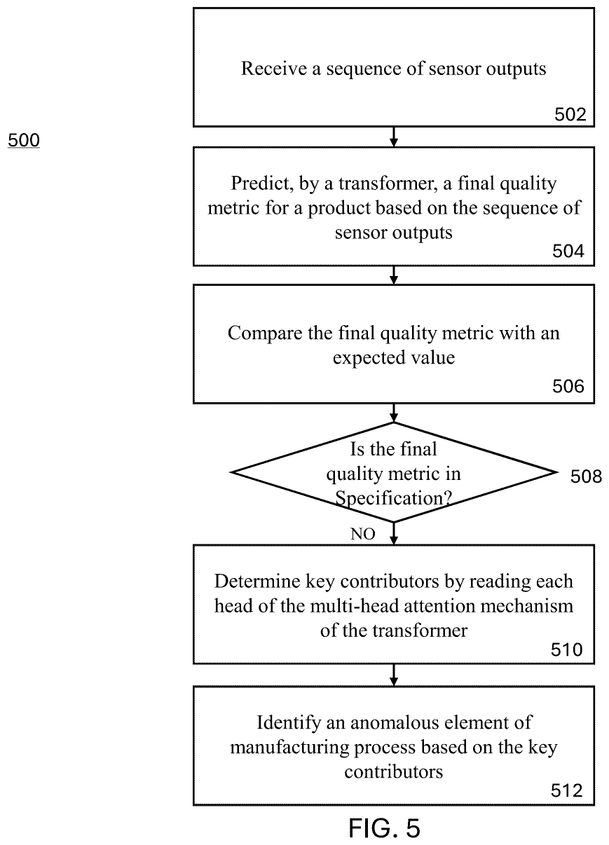

FIG. 5 is an illustrative method 500 that provides a comprehensive approach for evaluating manufacturing quality metrics through transformer-based analysis and specification compliance assessment within industrial production environments. The method 500 may be implemented within the SCADA system 100 to enhance quality control capabilities by utilizing the machine learning algorithms 104. In some cases, the method 500 may process sequential data collected from the sensors 108 through the field controllers 106, where the measurements undergo specialized analysis to predict final product quality characteristics and detect deviations from manufacturing specifications. The method 500 may utilize decision-making algorithms and multi-head attention mechanisms to systematically evaluate quality outcomes and identify process elements that contribute to specification violations or manufacturing anomalies.

The method 500 may include a step 502 that receives a sequence of sensor outputs from monitoring devices distributed throughout the manufacturing environment. The step 502 may collect time-ordered measurements from the sensors 108 within the SCADA system 100, where each sensor contributes data streams representing process parameters that may influence final product quality characteristics. In some cases, the step 502 may synchronize data collection across multiple sensor types to ensure temporal alignment and enable accurate correlation analysis between process conditions and quality outcomes. The step 502 may also implement data validation procedures to identify sensor malfunctions, communication errors, or missing measurements that could compromise the accuracy of subsequent quality predictions within the method 500.

The method 500 may include a step 504 that utilizes a transformer model to predict a final quality metric for manufactured products based on the sequence of sensor outputs received in the step 502. The step 504 may implement the transformer model 306 or similar neural network architectures that incorporate attention mechanisms for analyzing relationships between process parameters and product quality characteristics. In some cases, the step 504 may generate predictions for quality metrics such as thickness uniformity, dimensional accuracy, or resistivity based on current and historical sensor readings. The step 504 may produce quality predictions with associated confidence intervals or uncertainty estimates that indicate the reliability of the forecasted quality outcomes under current manufacturing conditions.

The method 500 may include a step 506 that compares the final quality metric predicted in the step 504 with an expected value or target specification for the manufactured product. The step 506 may access predetermined quality standards, customer requirements, or manufacturing specifications that define acceptable ranges for the predicted quality metric. In some cases, the step 506 may calculate deviation measurements that quantify the difference between predicted and expected quality values, providing numerical assessments of specification compliance. The step 506 may also apply Statistical Process Control (SPC) rules on differences between predicted and actual quality metric values to enhance anomaly detection capabilities and identify systematic deviations from expected manufacturing performance.

The method 500 may include a decision step 508 that determines whether the final quality metric predicted in the step 504 falls within acceptable specification limits based on the comparison performed in the step 506. The decision step 508 may evaluate the deviation measurements against predetermined tolerance ranges, quality thresholds, or specification boundaries to classify the predicted quality outcome as compliant or non-compliant. In some cases, the decision step 508 may consider measurement uncertainty, process variability, or prediction confidence levels when making specification compliance determinations. The decision step 508 may generate binary classification results that direct the method 500 toward different processing paths depending on whether the predicted quality metric meets manufacturing specifications.

When the decision step 508 determines that the final quality metric does not meet specification requirements, the method 500 may include a step 510 that identifies contributors to the specification violation through analysis of multi-head attention mechanisms within the transformer model. The step 510 may examine attention matrices generated by individual transformer heads that focus on specific quality characteristics or process relationships, similar to the transformer head n attention matrix 314 described in the transformer system 300. In some cases, the step 510 may read each head of the multi-head attention mechanism to determine which sensors, process parameters, or time periods contribute most significantly to the predicted quality deviation. The step 510 may rank contributing factors according to their attention weights, providing manufacturing engineers with detailed insights into the root causes of quality specification violations.

Following the identification of contributing factors in the step 510, the method 500 proceeds to a step 512 that identifies an anomalous element of the manufacturing process based on the contributors determined through the multi-head attention analysis. The step 512 may analyze the attention weight distributions and contribution rankings to pinpoint specific process elements, equipment components, or operating conditions that exhibit unusual behavior patterns. In some cases, the step 512 may compare current attention patterns with historical baselines to identify sensors or process parameters that show abnormal influence levels on quality outcomes. The step 512 may generate diagnostic reports or alerts that highlight the identified anomalous elements, enabling targeted investigation and corrective action to address the underlying causes of quality specification failures within the manufacturing process.

### Example Graphical User Interfaces

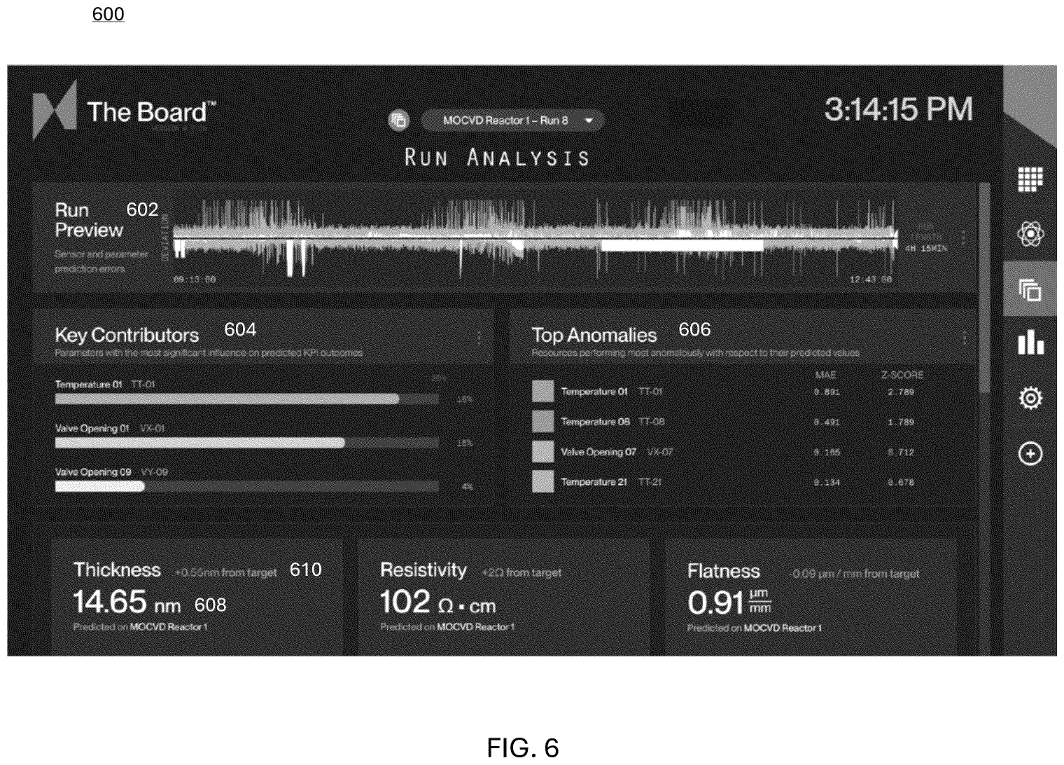

FIG. 6 is a graphical user interface 600, according to example embodiments. Graphical user interface 600 provides a comprehensive visual framework for analyzing manufacturing process data through integrated display components that enable real-time monitoring and assessment of production quality metrics. The graphical user interface 600 may be implemented as part of the HMI 102 within the SCADA system 100 to enhance the visualization capabilities of the machine learning algorithm 104 through specialized display elements that present analytical results from transformer-based processing systems. In some cases, the graphical user interface 600 may receive data streams processed by the transformer system 300 and present the analytical results in formats that enable manufacturing operators to quickly assess process performance and identify potential quality issues. The graphical user interface 600 may integrate multiple display sections that simultaneously present different aspects of manufacturing analysis, allowing users to correlate process behavior patterns with quality outcomes and anomaly detection results.

The graphical user interface 600 incorporates a run preview 602 that displays temporal analysis results to reveal process behavior patterns over manufacturing run durations. The run preview 602 may present interactive charts showing parameterized distributions using minimum, maximum, lower quartile, upper quartile and median values for all sensors' absolute prediction error at each timestamp within the manufacturing process. In some cases, the run preview 602 may utilize the sensor average 220 calculations and quartile parameters 218 generated through the system 200 to create statistical representations of process predictability across multiple sensor channels. The run preview 602 may render visual indicators that highlight time periods when manufacturing processes exhibit unusual behavior patterns or deviations from expected sensor response characteristics, enabling operators to identify temporal correlations between process disturbances and quality outcomes.

The graphical user interface 600 may include key contributors 604 that display analytical results identifying which process parameters or sensor measurements have the greatest influence on current manufacturing conditions. The key contributors 604 may present attention weight information derived from the trunk attention matrix 310 or similar analytical results generated by the transformer model 306 during process analysis operations. In some cases, the key contributors 604 may rank process elements according to their relative influence levels, providing manufacturing operators with prioritized lists of parameters that warrant focused monitoring or control attention. The key contributors 604 may display numerical influence percentages, graphical representations, or color-coded indicators that communicate the relative importance of different manufacturing variables in determining overall process behavior and quality outcomes.

The graphical user interface 600 displays top anomalies 606 that present detection results highlighting manufacturing process elements that exhibit unusual behavior patterns or deviations from expected operating characteristics. The top anomalies 606 may display analytical results generated through comparison 214 operations or similar deviation detection techniques that identify sensors or process parameters showing significant differences between predicted and measured values. In some cases, the top anomalies 606 may present statistical metrics such as Mean Absolute Error values representing how much predictions vary from measured results across time dimensions, or Z-score measurements indicating the difference between observed values and sample means scaled by standard deviation. The top anomalies 606 may provide ranked lists of anomalous elements with associated severity indicators, enabling manufacturing operators to prioritize investigation efforts on the most significant process deviations.

In some embodiments, the manufacturing system may include redundancy. In such cases the SCADA system 100 may automatically divert production away from machinery with elevated anomalies. Alternatively, in some cases, the SCADA system 100 may automatically adjust control parameters of effected machinery to reduce anomalies.

The SCADA system 100 may implement various automatic control adjustments in response to detected anomalies to maintain manufacturing quality and process stability. In some cases, when the system detects temperature anomalies through the sensors 108, the SCADA system 100 may automatically adjust heating element power levels, modify cooling system flow rates, or alter chamber ventilation parameters through the instrumentation output 110 to restore temperature uniformity within specification limits. Additionally, when pressure or flow rate anomalies are identified, the system may automatically regulate valve positions, adjust pump speeds, or modify gas flow controller settings to compensate for detected deviations and prevent quality metric degradation. The SCADA system 100 may also implement predictive control adjustments based on attention matrix analysis from the transformer model 306, where the system proactively modifies process parameters before anomalies fully develop, such as adjusting precursor gas ratios in semiconductor manufacturing processes when early indicators suggest potential thickness uniformity issues.

In some embodiments, the graphical user interface 600 displays one or more final quality metrics 608 that present predicted values for manufacturing quality characteristics that determine product acceptability and specification compliance. The final quality metric 608 may represent quality predictions generated by the KPI outputs from the transformer system 300, where each metric corresponds to specific product characteristics such as dimensional accuracy or resistivity. In some cases, the final quality metric 608 may include numerical values with associated units of measurement, providing manufacturing operators with quantitative assessments of expected product quality under current process conditions. The final quality metric 608 may be updated in real-time as new sensor data becomes available, enabling continuous monitoring of quality trends throughout manufacturing operations.

The graphical user interface 600 includes a final quality metric assessment 610 that provides comparative analysis results indicating how the final quality metric 608 relates to predetermined specification limits, target values, or acceptable quality ranges. The final quality metric assessment 610 may display deviation measurements, where predicted quality values are evaluated against expected manufacturing standards. In some cases, the final quality metric assessment 610 may utilize color-coded indicators, numerical deviation values, or graphical representations that communicate specification compliance status to manufacturing operators. The final quality metric assessment 610 may provide immediate visual feedback regarding whether current manufacturing conditions are likely to produce products that meet quality requirements, enabling proactive adjustments to process parameters before quality issues occur in finished products.

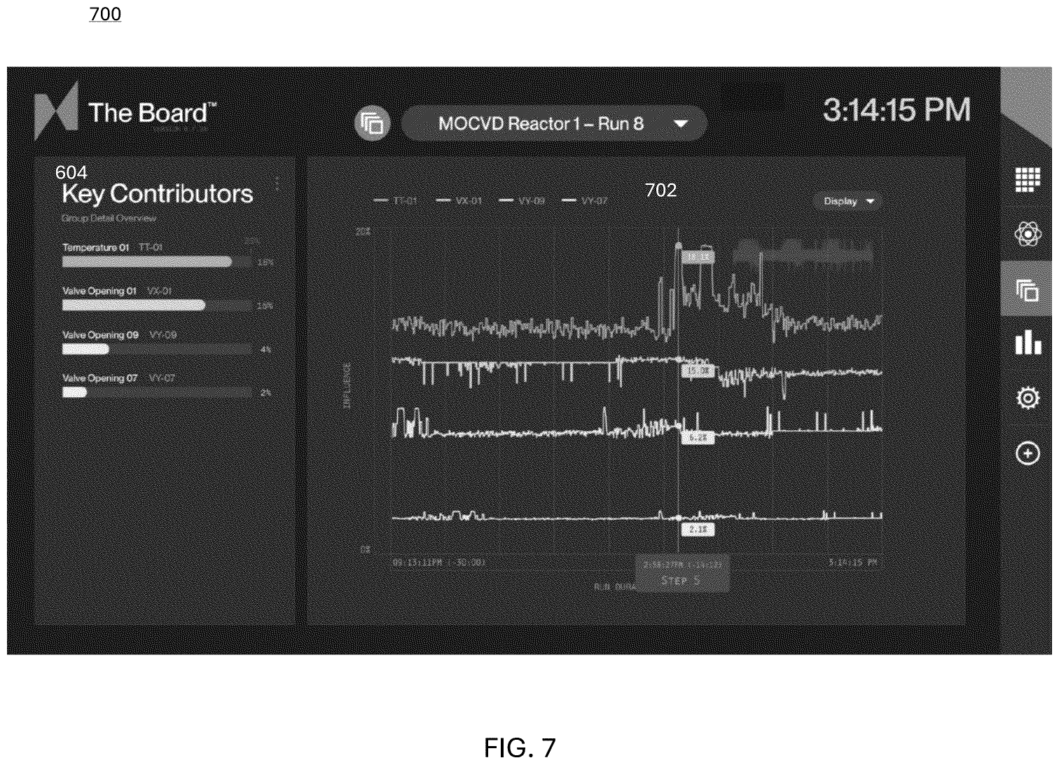

FIG. 7 is a graphical user interface 700, according to example embodiments. Graphical user interface 700 provides specialized visualization capabilities for monitoring temporal patterns of manufacturing process parameters through time-based analytical displays that enable detailed examination of key contributor 604 behavior over manufacturing run durations. The graphical user interface 700 may be implemented within the SCADA system 100 to enhance the temporal analysis capabilities of the machine learning algorithm 104 through interactive display components that present time-series data from the sensors 108 processed through the field controllers 106. In some cases, the graphical user interface 700 may receive analytical results from the transformer system 300 or similar processing systems that generate attention-based insights about process parameter influences on manufacturing outcomes. The graphical user interface 700 may provide manufacturing operators with detailed temporal perspectives on process behavior that complement the summary information presented in other analytical interfaces, enabling focused investigation of specific time periods or parameter interactions that affect manufacturing quality.

The graphical user interface 700 may depict the key contributors over time graphically 702. The graph may present a temporal visualization of key contributors through overlapping waveform representations plotted against manufacturing run timelines.

The key contributors vs. time graph 702 may provide interactive functionality that enables manufacturing operators to examine specific time periods within manufacturing runs and view detailed sensor behavior during selected temporal intervals.

The graphical user interface 700 may enable temporal correlation analysis between different key contributors through the simultaneous display of multiple data streams within the key contributors over time graph 702. The temporal visualization may reveal relationships between process variables that might not be apparent through individual parameter monitoring or summary statistical displays. In some cases, the key contributors over time graph 702 may highlight time periods where multiple parameters exhibit coordinated behavior changes, indicating system-wide process events or equipment interactions that affect manufacturing outcomes. The graphical user interface 700 may provide manufacturing operators with comprehensive temporal perspectives that support root cause analysis, process optimization decisions, and preventive maintenance planning based on observed parameter behavior patterns over manufacturing run durations.

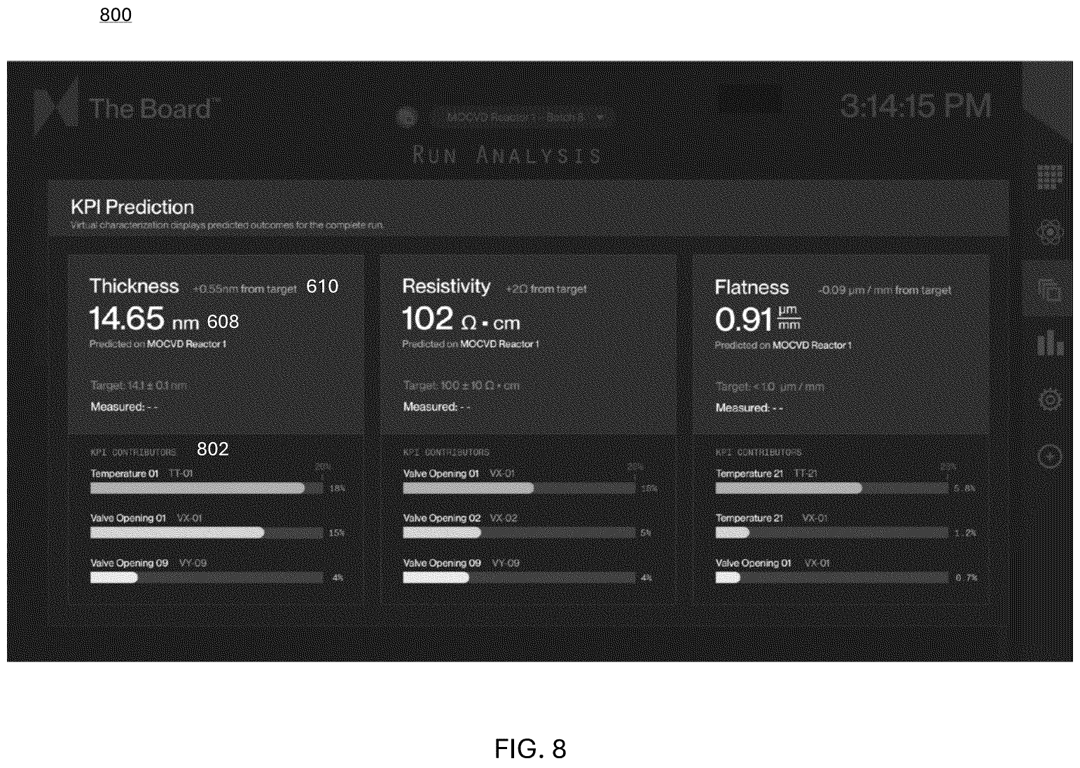

FIG. 8 is a graphical user interface 800, according to example embodiments. Graphical user interface 800 provides specialized visualization capabilities for presenting manufacturing quality predictions through integrated display components that enable comprehensive assessment of process performance and parameter influences within industrial production environments. The graphical user interface 800 may be implemented within the HMI 102 in the SCADA system 100 to visualize the predictive analysis capabilities of the machine learning algorithm 104 through dedicated display elements that present KPI forecasting results generated by the transformer system 300 or similar analytical processing systems. In some cases, the graphical user interface 800 may receive prediction data from the KPI 1 316a, KPI 2 316b, to KPI n 316c outputs and present the analytical results in formats that enable manufacturing operators to evaluate expected quality outcomes and understand the underlying process factors that influence product characteristics.

The graphical user interface 800 may depict the final quality metrics 608 and/or an assessment 610 of their variance from an expected value.

The graphical user interface 800 may depicts key contributors 802 that displays analytical results identifying specific process parameters or sensor measurements that exhibit the highest influence levels on the predicted quality outcomes presented in the final quality metric 608. The key contributors 802 may present attention weight information derived from the transformer head n attention matrix 314 or similar analytical results generated by specialized transformer heads that focus on particular manufacturing quality characteristics. In some cases, the key contributors 802 may include ranked lists of process elements according to their relative influence percentages, providing manufacturing operators with detailed insights into which manufacturing variables contribute most significantly to quality predictions. The key contributors 802 may present parameter names, numerical influence values, or graphical representations that communicate the relative importance of different process factors in determining expected product quality characteristics.

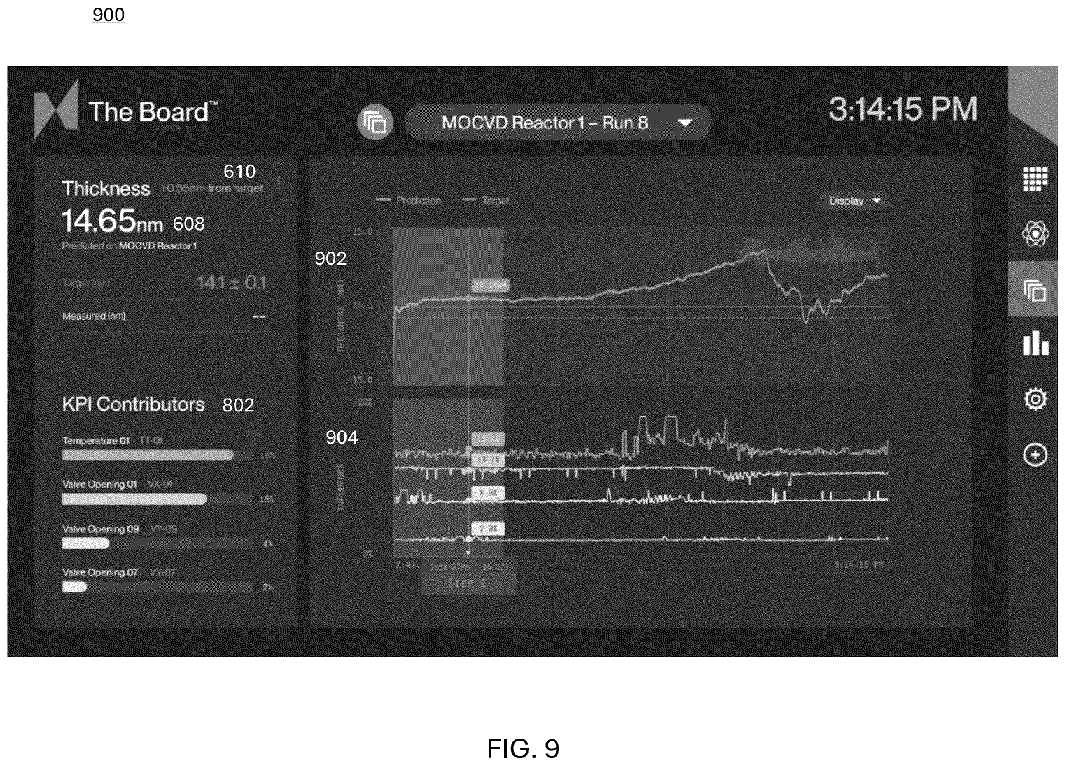

Referring to FIG. 9 is a graphical user interface 900, according to example embodiments. Graphical user interface 900 may provide comprehensive visualization capabilities for monitoring manufacturing process parameters through integrated time-series displays that enable detailed examination of quality metrics and contributing factors over extended manufacturing run durations. The graphical user interface 900 may be implemented within the HMI 102 in the SCADA system 100.

The graphical user interface 900 may graphically depict a final quality metric over time 902. The graphical user interface 900 may further depict the key contributors to determining the final metric over time 904. Changes to the final quality metric and the key contributors may be depicted on the same time scale to allow users to easily see system events which altered the final quality metric.

The graphical user interface 900 may enable comprehensive batch analysis capabilities that support monitoring of manufacturing processes across multiple runs with multiple parts per run, where each run represents a complete manufacturing cycle and each part corresponds to individual substrates or products processed within that cycle. The temporal visualizations within the final quality metric over time 902 and key contributors over time 904 may track characteristics such as defect count, thickness uniformity, or other quality parameters across multiple substrates processed during sequential manufacturing runs. In some cases, the graphical user interface 900 may provide functionality that enables manufacturing operators to examine quality variations between different parts within individual runs, as well as quality trends that develop across multiple sequential runs over extended time periods. The batch analysis capabilities may support comprehensive process assessment that enables identification of systematic quality variations, equipment drift patterns, or process optimization opportunities that affect manufacturing outcomes across multiple production cycles and substrate processing operations.

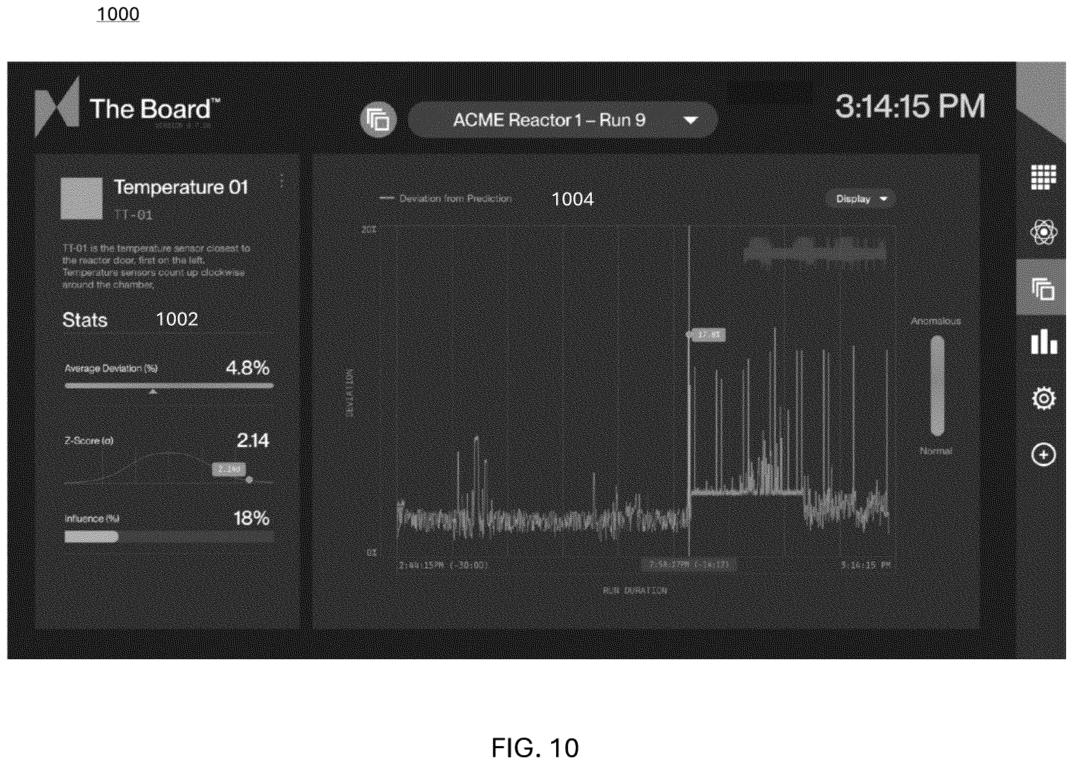

FIG. 10 is a specialized sensor monitoring graphical user interface 1000, according to example embodiments. The specialized sensor monitoring graphical user interface 1000 provides detailed analytical capabilities for examining individual sensor performance through comprehensive statistical displays and temporal visualization components within manufacturing process control environments. The sensor monitoring interface 1000 may be implemented within the HMI 102 in the SCADA system 100 to enhance the individual sensor analysis capabilities of the machine learning algorithm 104 through dedicated display elements that present detailed performance metrics for specific monitoring devices.

The sensor monitoring interface incorporates sensor statistics 1002 that display comprehensive analytical metrics for individual monitoring devices through numerical indicators designed to quantify sensor performance and prediction accuracy characteristics. The sensor statistics 1002 may present Mean Absolute Error (MAE) metrics representing how much predictions vary from measured values across time dimensions, where the MAE calculations provide quantitative assessments of prediction accuracy for specific sensor channels within the manufacturing environment. In some cases, the sensor statistics 1002 may display average deviation percentages that indicate the typical magnitude of differences between predicted and measured sensor values over specified time intervals. The sensor statistics 1002 may also present Z-score metrics representing the difference between observed values and sample mean scaled by standard deviation for prediction errors, where the Z-score calculations provide statistical assessments of how unusual current sensor behavior appears relative to historical performance patterns.

The sensor statistics 1002 may include influence percentage values that quantify the relative importance of individual sensors in determining overall manufacturing process behavior or quality outcomes. The influence percentages may be derived from attention weight analysis performed by the transformer model 306 or similar analytical systems that evaluate sensor contributions to process understanding and prediction accuracy. In some cases, the sensor statistics 1002 may present multiple statistical indicators simultaneously, allowing manufacturing operators to assess sensor performance from different analytical perspectives within a single display interface. The sensor statistics 1002 may utilize numerical formatting, color coding, or other visual indicators that communicate sensor performance status and enable rapid identification of monitoring devices that warrant detailed investigation or maintenance attention.

The sensor monitoring interface 1000 may depict sensor deviation over time 1004. The sensor monitoring interface 1000 may graphically present a temporal visualization of individual sensor performance through time-series plotting techniques designed to reveal deviation patterns and anomaly characteristics over manufacturing run durations. The sensor deviation over time 1004 may display continuous plots showing the magnitude of differences between predicted and measured sensor values across specified time intervals, where the temporal visualization enables manufacturing operators to observe deviation trends and identify time periods when sensor behavior deviates significantly from expected patterns. In some cases, the sensor deviation over time 1004 may utilize the comparison 214 results and absolute value 216 calculations generated through analytical processing systems to create temporal representations of sensor prediction accuracy and anomaly detection results. The sensor deviation over time 1004 may present timeline displays with timestamps along horizontal axes and deviation measurements along vertical axes, providing chronological perspectives on sensor performance that enable correlation analysis between deviation patterns and manufacturing process events.

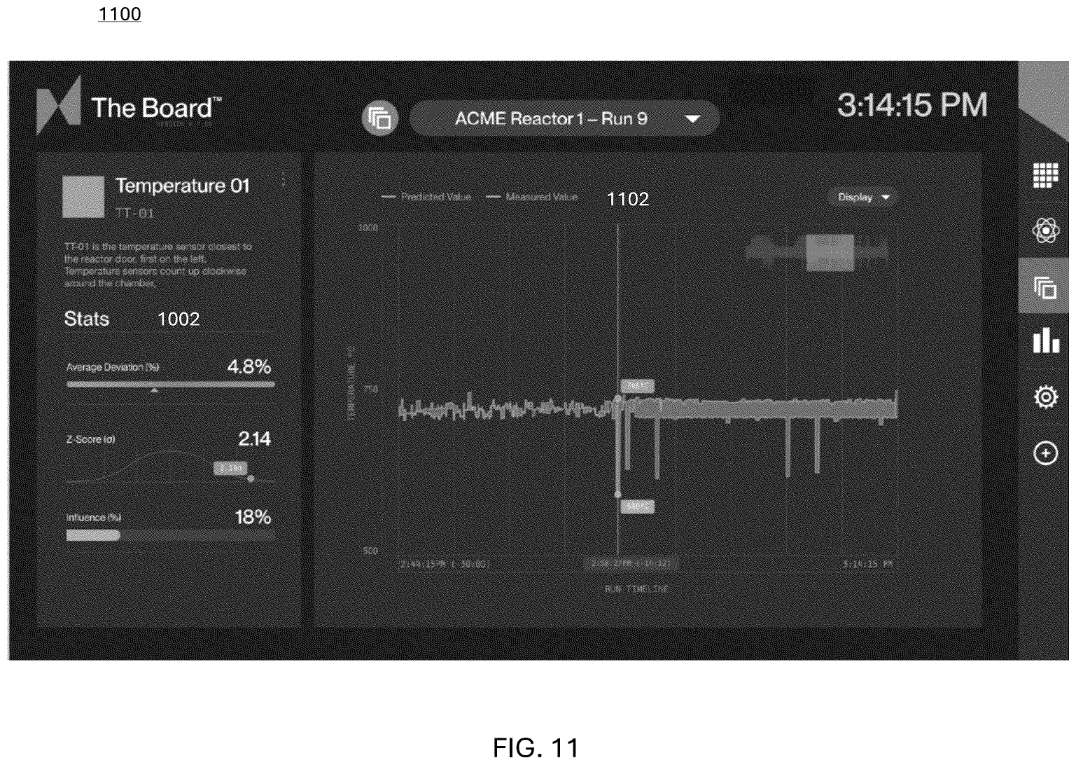

FIG. 11 is a specialized sensor analysis interface 1100, according to example embodiments. Specialized sensor analysis interface 1100 provides comprehensive visualization capabilities for evaluating anomalies in sensor readings through direct comparison of forecasted and actual sensor measurements within manufacturing process monitoring environments.

The sensor analysis interface 1100 may graphically present a sensor predicted vs measured values over time 1102. The graph may present temporal visualization of both forecasted and actual sensor measurements through coordinated time-series plotting techniques configured to reveal deviation characteristics over manufacturing run durations. The sensor predicted vs measured value over time 1102 may display continuous plots showing predicted sensor values alongside corresponding measured values across specified time intervals, where the temporal visualization enables manufacturing operators to observe correlation patterns and identify time periods when predictions diverge from actual sensor behavior.

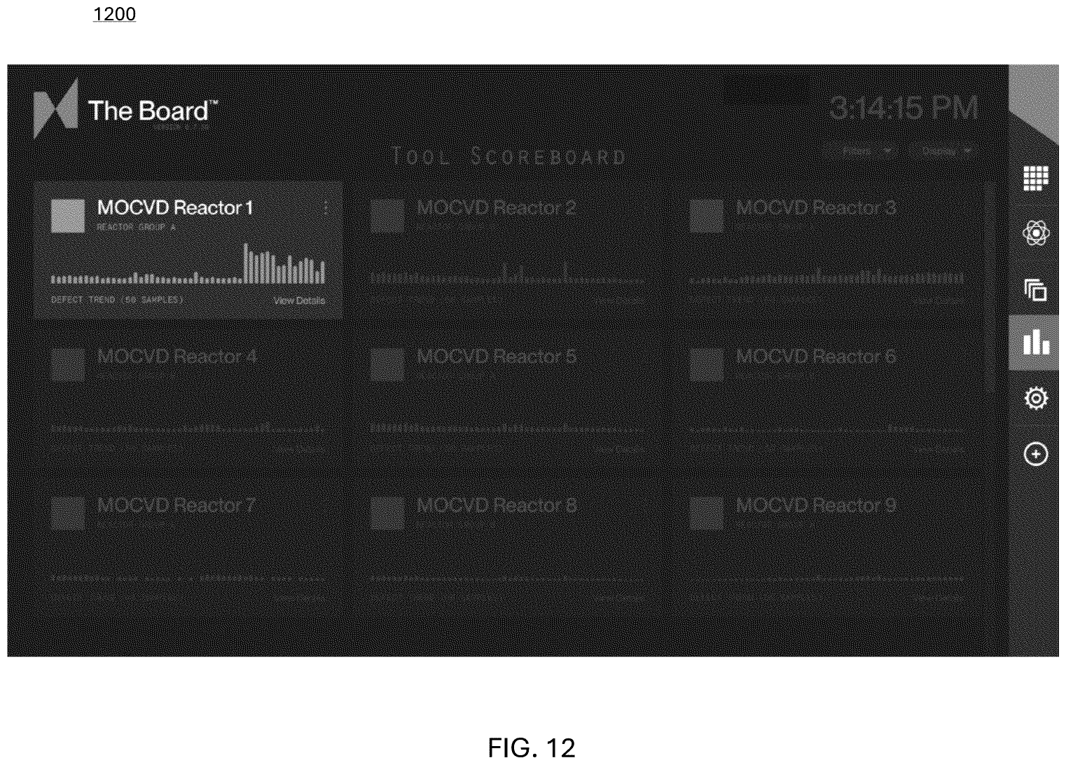

FIG. 12 is a graphical user interface 1200, according to example embodiments. Graphical user interface 1200 provides comprehensive monitoring capabilities for multiple manufacturing components through specialized scoreboard visualization techniques designed to enable simultaneous oversight of numerous process stations within manufacturing environments. The graphical user interface 1200 may be implemented within the HMI 102 in the SCADA system 100 to enhance the multi-component monitoring capabilities of the machine learning algorithm 104 through integrated display elements that present performance metrics for multiple manufacturing tools operating concurrently. In some cases, the graphical user interface 1200 may receive data streams from the sensors 108 distributed across multiple manufacturing stations and processed through the field controllers 106, where each manufacturing component contributes individual performance data that undergoes analytical processing to generate comparative assessments across the entire manufacturing facility. The graphical user interface 1200 may provide manufacturing operators with comprehensive facility-wide perspectives that enable identification of performance variations between different manufacturing tools and support coordinated process management decisions across multiple production lines.

Although one or more example applications described herein are geared to a semiconductor fabrication facility, those skilled in the art understand, that the concepts apply across all manufacturing processes, and the semiconductor fabrication facility is an exemplary use case.

### Example Computing Systems

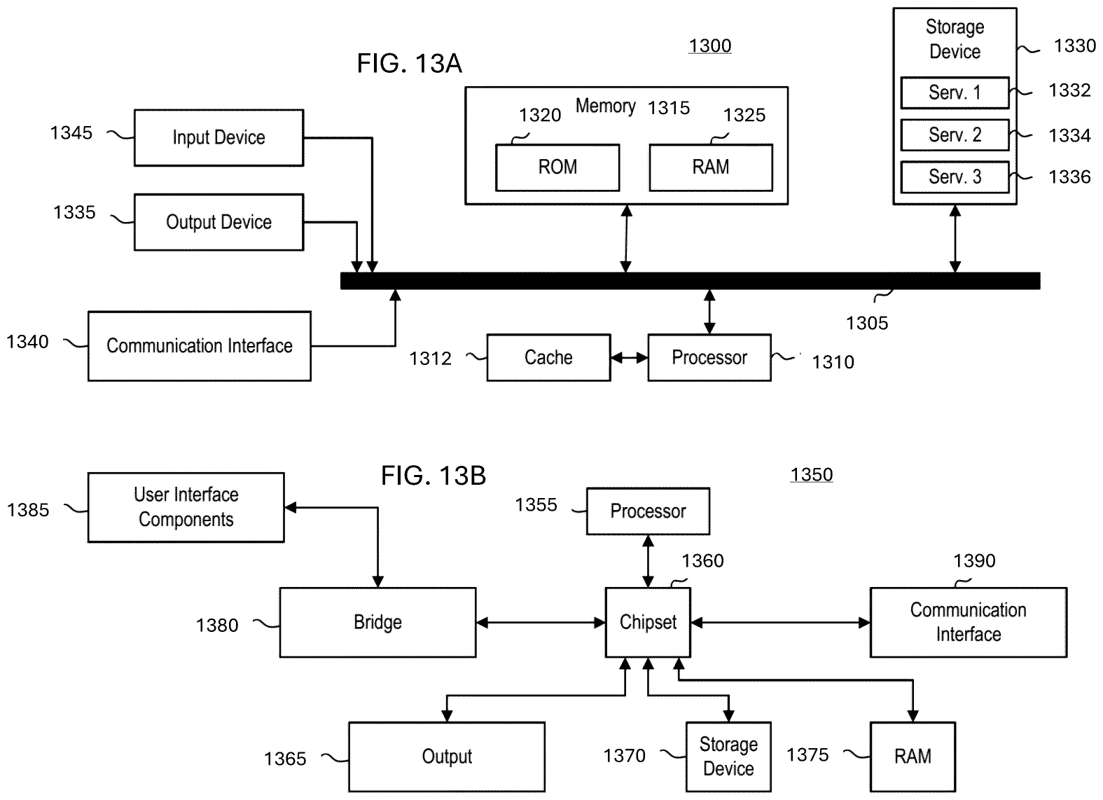

FIG. 13A illustrates a system bus architecture of computing system 1300, according to example embodiments. System 1300 may be representative of one or more computing systems configured to perform the processes described herein. One or more components of system 1300 may be in electrical communication with each other using a bus 1305. System 1300 may include a processing unit (CPU or processor) 1310 and a system bus 1305 that couples various system components including the system memory 1315, such as read only memory (ROM) 1320 and random-access memory (RAM) 1325, to processor 1310.

System 1300 may include a cache of high-speed memory connected directly with, in close proximity to, or integrated as part of processor 1310. System 1300 may copy data from memory 1315 and/or storage device 1330 to cache 1312 for quick access by processor 1310. In this way, cache 1312 may provide a performance boost that avoids processor 1310 delays while waiting for data. These and other modules may control or be configured to control processor 1310 to perform various actions. Other system memory 1315 may be available for use as well. Memory 1315 may include multiple different types of memory with different performance characteristics. Processor 1310 may include any general-purpose processor and a hardware module or software module, such as service 1 1332, service 2 1334, and service 3 1336 stored in storage device 1330, configured to control processor 1310 as well as a special-purpose processor where software instructions are incorporated into the actual processor design. Processor 1310 may essentially be a completely self-contained computing system, containing multiple cores or processors, a bus, memory controller, cache, etc. A multi-core processor may be symmetric or asymmetric.

To enable user interaction with the computing system 1300, an input device 1345 may represent any number of input mechanisms, such as a microphone for speech, a touch-sensitive screen for gesture or graphical input, keyboard, mouse, motion input, speech and so forth. An output device 1335 may also be one or more of a number of output mechanisms known to those of skill in the art. In some instances, multimodal systems may enable a user to provide multiple types of input to communicate with computing system 1300. Communications interface 1340 may generally govern and manage the user input and system output. There is no restriction on operating on any particular hardware arrangement and therefore the basic features here may easily be substituted for improved hardware or firmware arrangements as they are developed.

Storage device 1330 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 1325, read only memory (ROM) 1320, and hybrids thereof.

Storage device 1330 may include services 1332, 1334, and 1336 for controlling the processor 1310. Other hardware or software modules are contemplated. Storage device 1330 may be connected to system bus 1305. In one aspect, a hardware module that performs a particular function may include the software component stored in a computer-readable medium in connection with the necessary hardware components, such as processor 1310, bus 1305, output device 1335 (e.g., display), and so forth, to carry out the function.

FIG. 13B illustrates a computer system 1350 having a chipset architecture that may represent one or more computing systems configured to perform the processes described herein. Computer system 1350 may be an example of computer hardware, software, and firmware that may be used to implement the disclosed technology. System 1350 may include a processor 1355, representative of any number of physically and/or logically distinct resources capable of executing software, firmware, and hardware configured to perform identified computations. Processor 1355 may communicate with a chipset 1360 that may control input to and output from processor 1355.

In this example, chipset 1360 outputs information to output 1365, such as a display, and may read and write information to storage device 1370, which may include magnetic media, and solid-state media, for example. Chipset 1360 may also read data from and write data to storage device 1375 (e.g., RAM). A bridge 1380 for interfacing with a variety of user interface components 1385 may be provided for interfacing with chipset 1360. Such user interface components 1385 may include a keyboard, a microphone, touch detection and processing circuitry, a pointing device, such as a mouse, and so on. In general, inputs to system 1350 may come from any of a variety of sources, machine generated and/or human generated.

Chipset 1360 may also interface with one or more communication interfaces 1390 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 1355 analyzing data stored in storage device 1370 or storage device 1375. Further, the machine may receive inputs from a user through user interface components 1385 and execute appropriate functions, such as browsing functions by interpreting these inputs using processor 1355.

It may be appreciated that example systems 1300 and 1350 may have more than one processor 1310 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and may be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

What is claimed:

1. A method for analyzing manufacturing process data, the method comprising:
receiving, by a processor, a sequence of sensor outputs from a plurality of sensors monitoring a manufacturing process;
predicting, by a transformer model executed by the processor, future parameters of the manufacturing process based on the sequence of sensor outputs;
generating one or more key influencers on a current system state based on an attention matrix of the transformer model;
analyzing the predicted parameters to identify an out-of-specification parameter; and
identifying one or more key contributors to the out-of-specification parameter based on an attention matrix of a transformer head associated with the out-of-specification parameter.

2. The method of claim 1, further comprising:
predicting, by the transformer model, a final quality metric for a product based on the sequence of sensor outputs;
comparing the final quality metric with an expected value;
determining whether the final quality metric is in specification;
in response to when the final quality metric is not in specification, determining the one or more key contributors by reading each head of a multi-head attention mechanism of the transformer model; and
identifying an anomalous element of the manufacturing process based on the one or more key contributors.

3. The method of claim 1, wherein the transformer model comprises encoding layers and decoding layers, and wherein predicting the future parameters comprises processing the sequence of sensor outputs through the encoding layers to generate encoded representations and processing the encoded representations through the decoding layers to generate the predicted future parameters.

4. The method of claim 1, wherein generating the one or more key influencers comprises:
analyzing attention weights in the attention matrix to determine which sensors in the plurality of sensors have a highest influence on the current system state.

5. The method of claim 2, wherein the final quality metric comprises at least one of thickness, resistivity, and flatness of the product.

6. The method of claim 2, wherein identifying the anomalous element comprises:
determining a deviation threshold and identifying sensors or process parameters that exceed the deviation threshold based on values of the attention matrix.

7. The method of claim 1, further comprising:
displaying the one or more key influencers and the one or more key contributors on a graphical user interface, wherein the graphical user interface includes a time series visualization of the sensor outputs and percentage contributions of each key influencer to the current system state.

8. A system for analyzing manufacturing process data, the system comprising:
a plurality of sensors configured to monitor a manufacturing process and generate sensor outputs;
a processor; and
a memory storing instructions that, when executed by the processor, cause the processor to perform operations comprising:
receiving a sequence of sensor outputs from the plurality of sensors;
predicting, using a transformer model, future parameters of the manufacturing process based on the sequence of sensor outputs;
generating one or more key influencers on a current system state based on an attention matrix of the transformer model;
analyzing the predicted parameters to identify an out-of-specification parameter; and
identifying one or more key contributors to the out-of-specification parameter based on an attention matrix of a transformer head associated with the out-of-specification parameter.

9. The system of claim 8, wherein the operations further comprise:
predicting, using the transformer model, a final quality metric for a product based on the sequence of sensor outputs;
comparing the final quality metric with an expected value;
determining whether the final quality metric is in specification;
in response to when the final quality metric is not in specification, determining the one or more key contributors by reading each head of a multi-head attention mechanism of the transformer model; and
identifying an anomalous element of the manufacturing process based on the one or more key contributors.

10. The system of claim 8, wherein the transformer model comprises encoding layers and decoding layers, and wherein predicting the future parameters comprises processing the sequence of sensor outputs through the encoding layers to generate encoded representations and processing the encoded representations through the decoding layers to generate the predicted future parameters.

11. The system of claim 8, wherein generating the one or more key influencers comprises:
analyzing attention weights in the attention matrix to determine which sensors in the plurality of sensors have a highest influence on the current system state.

12. The system of claim 9, wherein the final quality metric comprises at least one of thickness, resistivity, and flatness of the product.

13. The system of claim 9, wherein identifying the anomalous element comprises:
determining a deviation threshold and identifying sensors or process parameters that exceed the deviation threshold based on values of the attention matrix.

14. The system of claim 8, further comprising:
a display device configured to display the one or more key influencers and the one or more key contributors on a graphical user interface, wherein the graphical user interface includes a time series visualization of the sensor outputs and percentage contributions of each key influencer to the current system state.

15. A non-transitory computer-readable medium storing instructions that, when executed by a processor, cause the processor to perform a method for analyzing manufacturing process data, the method comprising:
receiving a sequence of sensor outputs from a plurality of sensors monitoring a manufacturing process;
predicting, by a transformer model, future parameters of the manufacturing process based on the sequence of sensor outputs;
generating one or more key influencers on a current system state based on an attention matrix of the transformer model;
analyzing the predicted parameters to identify an out-of-specification parameter; and
identifying one or more key contributors to the out-of-specification parameter based on an attention matrix of a transformer head associated with the out-of-specification parameter.

16. The non-transitory computer-readable medium of claim 15, wherein the method further comprises:
predicting, by the transformer model, a final quality metric for a product based on the sequence of sensor outputs;
comparing the final quality metric with an expected value;
determining whether the final quality metric is in specification;
in response to when the final quality metric is not in specification, determining the one or more key contributors by reading each head of a multi-head attention mechanism of the transformer model; and
identifying an anomalous element of the manufacturing process based on the one or more key contributors.

17. The non-transitory computer-readable medium of claim 15, wherein the transformer model comprises encoding layers and decoding layers, and wherein predicting the future parameters comprises processing the sequence of sensor outputs through the encoding layers to generate encoded representations and processing the encoded representations through the decoding layers to generate the predicted future parameters.

18. The non-transitory computer-readable medium of claim 15, wherein generating the one or more key influencers comprises analyzing attention weights in the attention matrix to determine which sensors in the plurality of sensors have a highest influence on the current system state.

19. The non-transitory computer-readable medium of claim 16, wherein identifying the anomalous element comprises determining a deviation threshold and identifying sensors or process parameters that exceed the deviation threshold based on values of the attention matrix.

20. The non-transitory computer-readable medium of claim 15, wherein the method further comprises displaying the one or more key influencers and the one or more key contributors on a graphical user interface, wherein the graphical user interface includes a time series visualization of the sensor outputs and percentage contributions of each key influencer to the current system state.
